(19) United States
(12) Patent Application Publication
(10) Pub. No.: US 2009/0268345 A1
(43) Pub. Date: Oct. 29, 2009

(54) HEAD SUSPENSION AND DISK DEVICE

(75) Inventor: Shinji Koganezawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/340,275

(22) Filed: Dec. 19, 2008

(30) Foreign Application Priority Data
Apr. 28, 2008 (JP) 2008-117727

(51) Int. Cl. G11B 5/60

(52) U.S. Cl. 360/234.6; G9B/5.229

(57) ABSTRACT

A disk device has a head reading/writing data from and to a disk medium, a head slider supporting the head, a head suspension having a gimbal mounting the head slider, gimbal supports supporting the gimbal, traces having a wirings pattern, and a carriage arm supporting the head suspension. Further, the disk device has vibration sensors, each of the vibration sensors arranged at each side of a centerline of the head slider along a longitudinal direction of the head suspension and a signal processing circuit processing output signals from the vibration sensors so as to remove up/down vibration components.

### CROSS-REFERENCE TO RELATED APPLICATIONS

This application is based upon and claims the benefit of priority of the prior Japanese Patent Application No. 2008-117727, filed on Apr. 28, 2008, the entire contents of which are incorporated herein by reference.

### FIELD

The embodiments discussed herein relate to a head suspension and disk device, more particularly relates to a head suspension and disk device having vibration sensors.

### BACKGROUND

In recent years, progress in digitalization and information processing has made large-sized storage devices necessary. Hard disk drives (HDD) and other disk devices are rapidly becoming higher in density. Along with this, the minimum storage size on the storage medium is becoming increasingly smaller.

A hard disk drive spins a magnetic disk at a high speed so as to produce a flow of air which is utilized to make a head slider float up. An actuator is used to position the head slider at a desired track to record/reproduce data. The actuator has a head suspension supporting the head slider at one end and a carriage arm provided with a voice coil at the other end. The carriage arm is supported and rotates about a spindle to move the head slider. If the storage size of the magnetic storage medium becomes smaller, a higher head positioning precision is sought from the actuator moving the head.

One of the main factors obstructing the positioning of the head is disk flutter. “Disk flutter” is the phenomenon where the flow of air caused by spinning of the storage medium causes the storage medium to vibrate. Disk flutter makes the storage medium vibrate and gives vibration to the slider floating above the storage medium to thereby cause the slider to vibrate in the track direction. This track direction vibration has a detrimental effect on the head positioning precision.

In the past, a magnetic disk drive system comprising, means for detecting displacement of the actuator in an axial direction relative to the disk, and for producing an output signal corresponding to said displacement, and a control system for generating a compensatory control signal from the output signal of the means for detecting, for counteracting effects of disk flutter has been proposed. Further, the method of using a piezoelectric sensor to detect deformation of the actuator and suppress resonance has been proposed (see Japanese Patent Publication (A) No. 2003-217244 and Japanese Patent No. 3208386).

### SUMMARY

In a first aspect of the head suspension, vibration sensors are arranged at gimbal supports at two sides of a gimbal.

In another aspect of the head suspension, vibration sensors are arranged at traces passing through two sides of a gimbal.

A disk device arranges vibration sensors at the two sides of a centerline of a head slider heading toward the longitudinal direction of the head suspension and uses a signal processing circuit to process output signals of the vibration sensors to remove up/down vibration components of a carriage arm.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

These and other objects and features of the embodiments will become clearer from the following description of embodiments given with reference to the attached drawings, wherein:

FIG. 1 is a view illustrating a magnetic disk device to which the present embodiment is applied;

FIG. 2 is a view illustrating an actuator of a magnetic disk device enlarged;

FIG. 3 is a view illustrating a head suspension disassembled;

FIG. 4 is a view illustrating deformation of a head suspension due to disk flutter;

FIG. 5 is a view illustrating sensors arranged at gimbal supports;

FIG. 6 is a view illustrating sensors arranged at traces;

FIG. 7A is a view illustrating a signal processing circuit using a voltage amplifier;

FIG. 7B is a view illustrating a signal processing circuit using a charge amplifier;

FIG. 8 is a view illustrating sensors arranged at back surfaces of gimbal supports of FIG. 5;

FIG. 9 is a view illustrating sensors arranged at back surfaces of traces of FIG. 6;

FIGS. 10A and 10B are views illustrating examples of interconnects of the sensors of the present embodiment; and

FIG. 11 is a view illustrating a signal processing circuit using the interconnects of FIG. 10B.

### DESCRIPTION OF EMBODIMENT

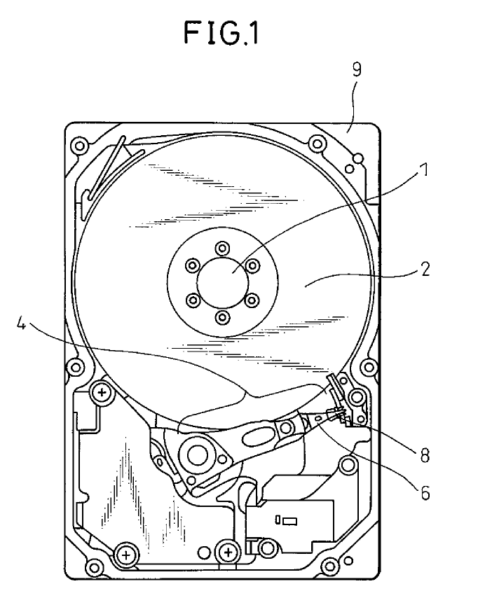

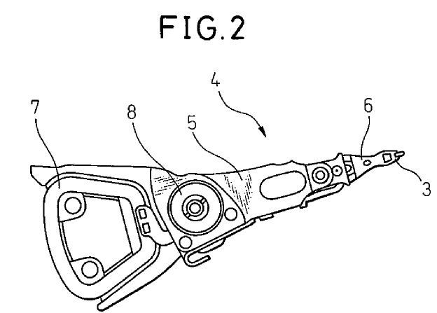

Below, an embodiment will be explained with reference to the drawings. FIG. 1 is a view illustrating an example of a magnetic disk device to which the present embodiment is applied. FIG. 2 is an enlarged perspective view of an actuator used for the magnetic disk device of FIG. 1.

As illustrated in FIG. 1, the magnetic storage medium 2 is fixed to a housing 9 to be able to spin by a spindle motor 1. An actuator 4 is provided with a head suspension 6 supporting a head slider 3 at its front end and is fixed to the housing 9 to be able to move in the approximately radial direction of the magnetic storage medium 2.

As illustrated in FIG. 2, one end of the head suspension 6 supports the head slider 3. The other end of the head suspension 6 is connected to one end of a carriage arm 5. The carriage arm 5 can rotate about a spindle through a bearing 8. Further, the other end of the carriage arm has a voice coil 7. By controlling the current flowing through the voice coil 7, the actuator 4 can position the head slider at a predetermined track on the magnetic disk.

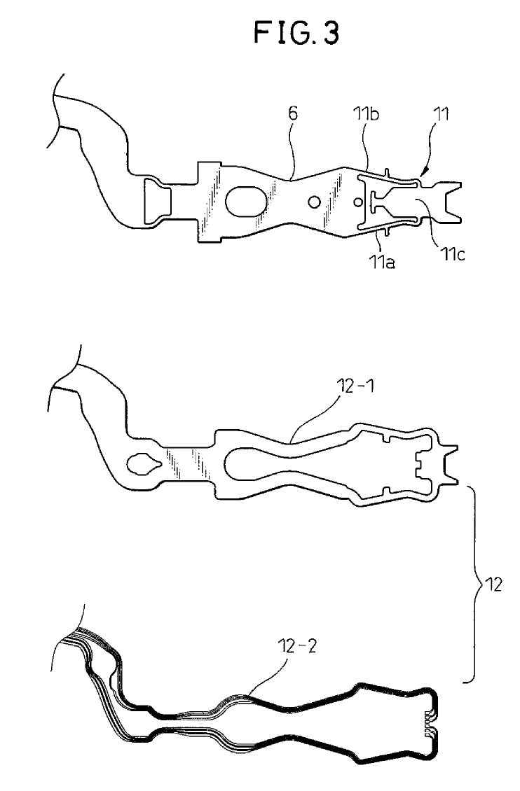

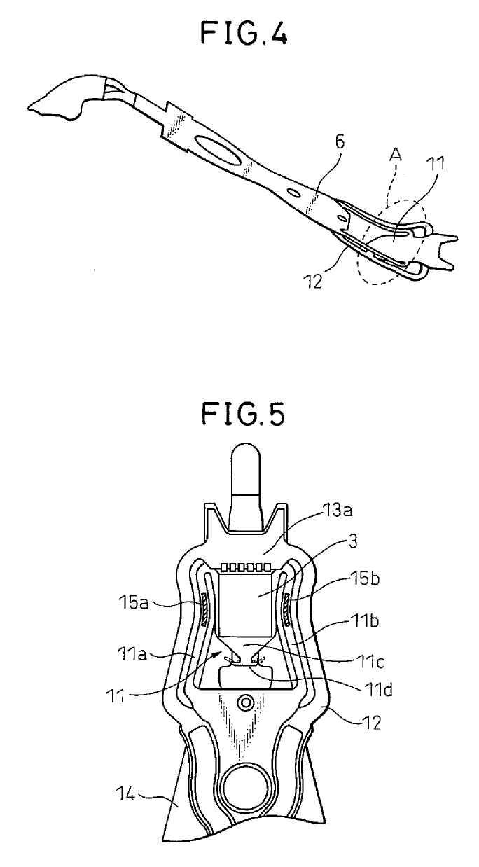

FIG. 3 is a view illustrating the head suspension and trace disassembled. The head suspension 6 is generally formed of stainless steel sheet. A gimbal 11 to which the head slider is attached is formed by etching the stainless steel sheet. The gimbal 11 has gimbal supports 11a and 11b and a slider mount 11c for mounting the head slider and can flexibly support the head slider. Note that in FIG. 4, the head slider is attached to the rear surface of the figure.

The traces 12 having wiring patterns to the head have flexible substrates 12-1 formed by polyimide and interconnect patterns 12-2 printed on the flexible board 12-1. The interconnect patterns 12-2 are connected to the head and carry read/write (R/W) signals.

FIG. 4 is a view illustrating deformation of a head suspension when disk flutter occurs due to high speed spinning of the disk. FIG. 4 illustrates the flexure when removing the load beam to facilitate understanding of the deformation of the head suspension 6. Further, the magnitude of the displacement is enlarged.

The disk flutter due to the high speed spinning of the disk has the detrimental effect on the head positioning precision, because the disk vibration is due to not just up/down vibration, but deformation of the disk and vibration with a slant with respect to the slider. The head slider trying to follow the disk vibrates so as to be tilted from the mounting surface of the head suspension 6. Therefore, the head suspension 6 itself undergoes torsional vibration. As shown in FIG. 4, a large torsional vibration appears at the vicinity A of the gimbal 11.

On the other hand, the up/down vibration of the arm supporting the head suspension 6 is the vibration of the mount surface of the head suspension 6 in the up/down direction. The arm up/down vibration is also accompanied with vibration of the gimbal 11. However, the arm up/down vibration does not give torsion to the gimbal 11.

In a structure just arranging a sensor at the head suspension, not only vibration of disk flutter, but also up/down vibration of the carriage arm supporting the head suspension also is detected. Further, the up/down vibration of the carriage arm does not give torsion or vibration to the head slider in the track direction. Therefore, if correcting the arm up/down vibration component inherently not causing positional deviation of the head, excess current flows through the voice coil. In other words, unnecessary positional deviation of the sensor occurred by trying to correct the arm up/down vibration component inherently not requiring correction.

In the present embodiment, by removing the up/down vibration components of the arm from the outputs of the sensors, just the disk flutter vibration due to the torsional vibration component is detected.

FIG. 5 is a partial enlarged view of a suspension mounting sensors at a gimbal according to the present embodiment.

The head slider 3 is mounted on the slider mount 11c of the gimbal 11. The slider mount 11c is flexibly connected to the head suspension body by the two gimbal supports 11a and 11b. The terminals of the head slider 3 are connected to R/W signal lines of the traces 12. The front end of the gimbal 11 is provided with an engagement part 11d engaging with a through hole provided in the load beam 14.

In the present embodiment, the two sensors 15a and 15b are adhered to the two gimbal supports 11a and 11b with large deformation due to disk flutter. The two gimbal supports 11a and 11b are positioned at the two sides of the longitudinal direction centerline of the head slider 3, so the phases of the torsional vibration components detected by the sensors 15a and 15b become opposite. Further, for the arm up/down vibration components, the outputs of the two sensors 15a and 15b are the same in phase and substantially the same in magnitude.

Therefore, if obtaining the difference of outputs of the two sensors 15a and 15b, the torsional vibration components are added while the arm up/down vibration component becomes substantially zero. Therefore, it is possible to use the difference of the outputs of the two sensors 15a and 15b to remove the arm up/down vibration components and enable detection of only the disk flutter vibration causing the torsional vibration. As a result, it is possible to use the difference of outputs of the two sensors 15a and 15b for feedforward control so as to accurately position the head.

For the sensors 15a and 15b, it is possible to use piezoelectric devices converting vibration given from the outside to voltage. The piezoelectric devices can be formed from PVDF (polyvinylidine difluoride) or thin film PZT (lead zirconium titanate) or another piezoelectric material. PVDF has the characteristic of being strong in shock resistance. If the thin film PZT, it can be expected that the properties as sensors will become good. Further, it is also possible to use strain gauges changing in resistance value in accordance with expansion and contraction of the measured object as sensors 15a and 15b.

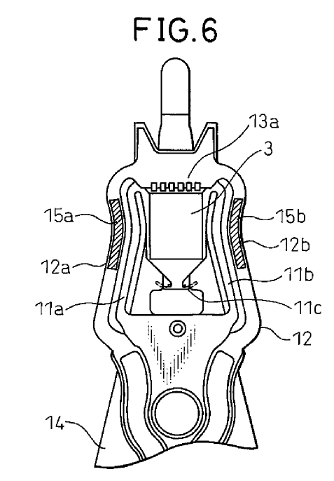

FIG. 6 is a partial enlarged view of a head suspension mounting sensors at the traces according to the present embodiment.

FIG. 6 illustrates part of the head suspension the same as FIG. 5. The difference from FIG. 5 is that the two sensors 15a and 15b are adhered to the traces 12a and 12b near the gimbal 11. As shown in FIG. 1, even the parts of the traces 12 positioned at the left and right of the gimbal at which the head slider 3 is arranged receive great deformation. Therefore, the sensors 15a, 15b adhered to the traces 12a, 12b near the gimbal 13 also can detect only the disk flutter if obtaining the difference of the detection outputs.

The pattern interconnects formed at the traces are obtained by forming copper lines for the R/W circuits on the base polyimide. The interconnect patterns for electrodes of the sensors 15a and 15b also can be formed on the R/W lines and traces. If using a conductive binder etc. to mount the sensors 15a and 15b on the traces 12a and 12b, electrical connection becomes easy and the assembly ability becomes superior in the structure.

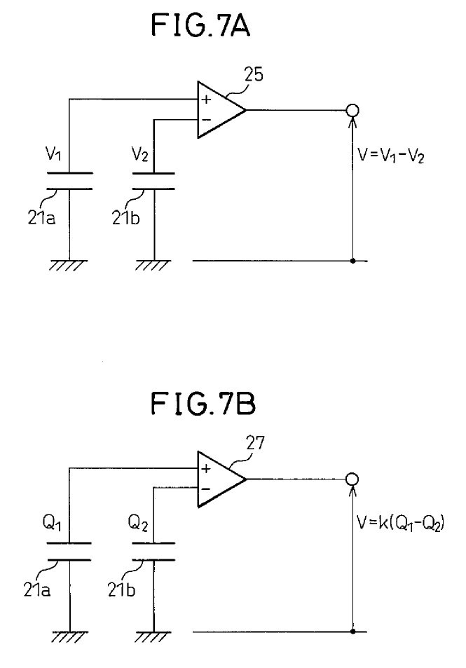

FIGS. 7A and 7B are views illustrating signal processing circuits for processing the signals obtained from the two sensors.

FIG. 7A illustrates a circuit of a differential amplifier receiving the detected signals from the two sensors as voltage signals. The two sensors 15a and 15b indicated in FIG. 5 and FIG. 6 are formed by piezoelectric devices 21a and 21b and the polarization directions of the piezoelectric devices are matched with the direction from the back side to front side of the paper surface. The electrode sides of the piezoelectric devices 21a and 21b visible at the surface are connected to the differential amplifier 25, while the electrodes at the back sides of the piezoelectric device 21a and 21b (in FIG. 5, the electrodes at the concealed surfaces) are connected to the ground. As explained above, the output V of the differential amplifier 25 becomes V=V₁−V₂ if receiving the input signals V₁ and V₂, so the up/down vibration of the gimbal and slider is cancelled and it is possible to detect only the torsional vibration. Note that the polarization directions and interconnects of the piezoelectric device are not limited to those explained above. It is possible to suitably select other polarization directions and interconnects able to give similar results.

FIG. 7B illustrates a signal processing circuit using a differential type charge amplifier. In the case of a sensor using a piezoelectric device, it is also possible to use a differential type charge amplifier to detect the output. If inputting the charges Q₁ and Q₂ detected by the piezoelectric devices 21a and 21b to the differential charge amplifier 27, the differential charge amplifier 27 outputs a signal V=k(Q₁−Q₂) proportional to the difference of the input charges Q₁ and Q₂.

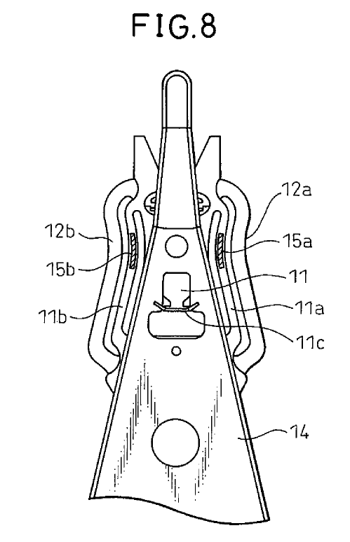

FIG. 8 is a view illustrating the surface at the opposite side to the head suspension shown in FIG. 5 and shows an example of adhering sensors 15a and 15b at the surfaces of the two gimbal supports 11a and 11b facing the load beam 14.

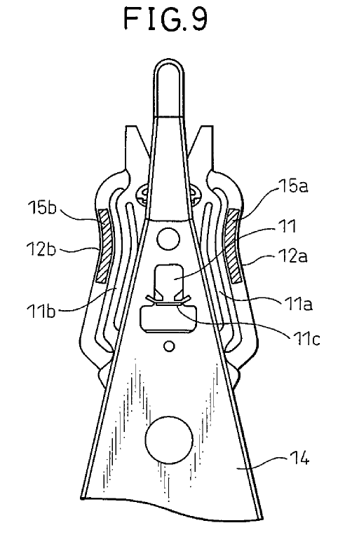

FIG. 9 is a view illustrating the opposite surface of the head suspension shown in FIG. 6 and illustrates an example of adhering the sensors 15a and 15b to the surfaces of the two traces 12a and 12b facing the load beam 14.

By arranging the sensors 15a and 15b as indicated in FIGS. 8 and 9 and finding the difference of the sensors 15a and 15b, like FIGS. 5 and 6, it is possible to detect only the torsional vibration component. Therefore, it is possible to obtain a correction signal for accurate positioning of the head.

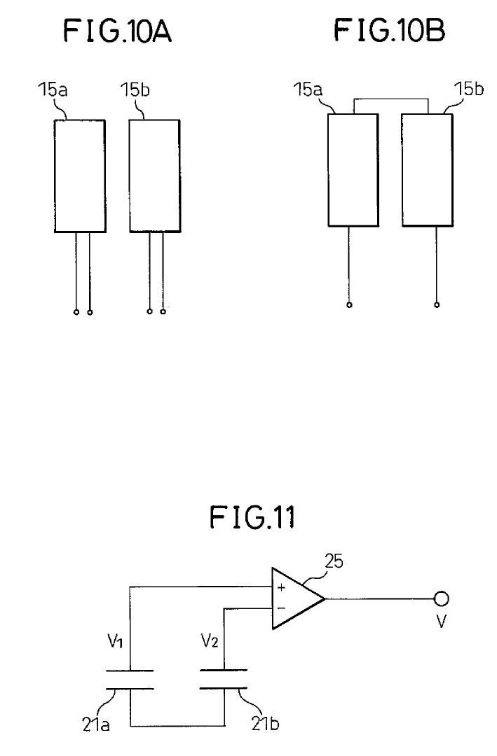

FIGS. 10A and 10B are views illustrating two methods of interconnection of the sensor. FIG. 10A illustrates the interconnects used for the circuits shown in FIGS. 7A and 7B. The outputs of the two sensor 15a and 15b are input to the differential amplifier 25 (or differential amplifier 27), so it is necessary to lay two wirings for each sensor. The wirings are integrally formed together with R/W signal lines as pattern wirings on the trace 12a. Therefore, the overall width of the pattern wirings can increase by the amount of increase of the number of wirings laid. The increased width of the pattern affects the rigidity of the gimbal and the result can be a gimbal structure with large fluctuation with respect to changes in temperature and humidity. That is, there is a concern over having an effect on the stability of flotation of the slider. Therefore, the number of wirings increased is preferably as small as possible.

Therefore, as illustrated in FIG. 10B, first terminals of the two sensors are connected in advance and the remaining lines are laid on the traces. In FIG. 10A, it was necessary to add two wiring patterns each on the traces (total four), but in FIG. 10B it is sufficient to just add one each (total two), so the effect on the gimbal rigidity can be kept small. However, to remove the arm up/down motion components and enable detection of the torsional vibration, it is necessary to connect the terminals together or suitably connect them for the polarity of the sensors.

FIG. 11 is a view of an example of a signal processing circuit with the wirings of FIG. 10B. First electrodes of the two piezoelectric devices 21a and 21b are directly connected, while second electrodes of the piezoelectric devices 21a and 21b are connected to differential inputs of the differential voltage amplifier 25. The connections become similar even when using a differential charge amplifier.

In the above-mentioned embodiment, a hard disk device was explained, but the present embodiment is not limited in application to a hard disk device. The present embodiment can be applied to any optomagnetic disk or optical disk or other disk device able to read and write information from and to a storage medium rotating at a high speed.

Further, when arranging the sensors, they are not limited to the above-mentioned gimbal supports or traces. They can be arranged at any positions so long as the two sides of the centerline of the head slider along the longitudinal direction of the actuator. For example, it is also possible to provide the sensors at the opposite surface of the gimbal from the mounting surface of the head slider.

Further, in the example of FIGS. 5 and 6 and FIGS. 8 and 9, the two sensors were arranged at the same surfaces, but it is also possible make the surface where one sensor is arranged and the surface where the other sensor is arranged different. Further, if making it so that the two sensors output signals with the same phases of the disk flutter components and with opposite phases of the arm up/down motion components, it is possible to obtain the sum of the signals from the two sensors to remove the arm up/down motion components.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A head suspension comprising:
a gimbal mounting a head slider;
gimbal supports supporting the gimbal; and
vibration sensors, each of vibration sensors arranged at each side of a centerline of the head slider along a longitudinal direction of the head suspension.

2. The head suspension as set forth in claim 1, wherein each of the vibration sensors are placed on each gimbal support.

3. The head suspension as set forth in claim 1, further comprising traces having a wiring pattern, wherein each of the vibration sensors are placed on a part of each of the traces at outer sides of the gimbal.

4. The head suspension as set forth in claim 1, wherein the output signals from the vibration sensors are input to a differential amplifier.

5. The head suspension as set forth in claim 4, wherein
first electrodes of the vibration sensors are connected to each other, and
second electrodes of the vibration sensors are connected to input terminals of the differential amplifier.

6. The head suspension as set forth in claim 1, wherein the vibration sensors are piezoelectric sensors.

7. The head suspension as set forth in claim 1 or 2, wherein the vibration sensors are strain gauges.

8. A disk device comprising:
a head reading/writing data from and to a disk medium;
a head slider supporting the head;
a head suspension having a gimbal mounting the head slider;
gimbal supports supporting the gimbal;
traces having a wirings pattern;
a carriage arm supporting the head suspension;
vibration sensors, each of the vibration sensors arranged at each side of a centerline of the head slider along a longitudinal direction of the head suspension;
a signal processing circuit processing output signals from the vibration sensors so as to remove up/down vibration components.

9. The disk device as set forth in claim 8, wherein the signal processing circuit has a differential amplifier outputting a difference of the output signals from the vibration sensors.

10. The disk device as set forth in claim 8, wherein each of the vibration sensors is placed on each gimbal support.

11. The disk device as set forth in claim 8, wherein each of the vibration sensors are placed on a part of each of the traces at outer sides of the gimbal.

12. The disk device as set forth in claim 8, wherein
first electrodes of the vibration sensors are mutually connected, and
second electrodes of the vibration sensors are connected to the signal processing circuit.

13. The disk device as set forth in claim 8, wherein the vibration sensors are piezoelectric sensors.

14. The disk device as set forth in claim 8, wherein the vibration sensors are strain gauges.
